(19) United States
(12) Patent Application Publication
(10) Pub. No.: US 2010/0292996 A1
(43) Pub. Date: Nov. 18, 2010

(54) APPARATUS AND METHOD FOR ENHANCED CLIENT RELATIONSHIP MANAGEMENT

(76) Inventors: Stephen A. Margrett, Sedona, AZ (US); Steven B. Hicks, Tucson, AZ (US); Simon L. Margrett, Pulborough (GB)

Correspondence Address: WRIGHT LAW GROUP, PLLC, 1959 SOUTH POWER ROAD, SUITE 103-376, MESA, AZ, 85206, US

(21) Appl. No.: 12/484,068

(22) Filed: Jun. 12, 2009

Related U.S. Application Data
(60) Provisional application No. 61/060,904, filed on Jun. 12, 2008.

(51) Int. Cl. G06Q 10/00; G06F 17/30; G06Q 30/00

(52) U.S. Cl. 705/1.1; 707/802; 707/E17.044

(57) ABSTRACT

The apparatus and methods disclosed herein provide a convenient and efficient computer-based process methodology for identifying and qualifying people for different solutions and outcomes and enrolling and/or registering people in appropriate programs as they are identified. The most preferred embodiments of the present invention comprise one or more structured computerized databases comprising: a set of outcomes, each with a corresponding set of appropriately-expressed eligibility requirements; a set of applications or forms and their corresponding necessary and unique named data elements, or variables, which may or may not relate to the aforementioned set of outcomes; a set of questions corresponding to the set of variables, each question relating to one or more variables; a set of question scripts corresponding to the set of questions, with one script per question; a set of question help prompt scripts corresponding to the set of questions, with one help prompt per question; a set of interview constructs that semantically relate sets of questions; and a subject definition comprised of named locations used to store variables and their corresponding values. Given the database and elements described above, the most preferred embodiments of the present invention comprise a system that performs: eligibility determination; data acquisition; and forms or application completion using collected data elements.

### RELATED APPLICATIONS

This non-provisional patent application claims the priority of U.S. Provisional Patent Application No. 61/060,904, which application was filed on Jun. 12, 2008, and which application is hereby incorporated by reference.

### BACKGROUND OF THE INVENTION

1. Field of the Invention

The present invention relates generally to computer systems used in conjunction with providing services, and more particularly, related to a computer-based system used for automated creation of, participation in, and/or management of activities or programs related to client or customer contact.

2. Background Art

In order to better service their clients and customers, the use of CRM (Customer Relationship Management) systems has been adopted by many businesses. A typical CRM system is generally used to maintain better relations between customers and an enterprise and, in certain businesses, may become the focal point used to enhance the satisfaction of customers by providing tools for tracking customer information and contact history. Most CRM systems are designed to unitarily manage information, such as customer attributes (e.g., name, address, gender, age, size, etc.) and points of contact with the enterprise (such as sales team members and support staff), share the information over the whole enterprise, and utilize the information to better facilitate customer contact and communication. With an appropriately configured CRM system, most enterprise activities for forming and maintaining relationships with customers can be conducted in a unified manner, and, in some circumstances, it becomes possible to construct and maintain reliable relations between customers and the enterprise or organization.

Alternatively, in some cases, a customer “portal” site is established on the Internet as an important means of communication and maintaining client contact in a CRM system. The customer portal site is generally a web page or group of web pages dedicated to each individual customer to provide each customer with specialized services. In many scenarios, a customer inputs a user ID and a password in a log-in page in the customer portal site and authentication is performed, then the customer can reference a web page or series of web pages dedicated to the customer, thereby allowing the customer to obtain certain services. Because of recent rapid spread of the Internet, it can be said that the customer portal site is the most important in providing customers with advanced service. However, in order to be effective, these systems are typically highly specialized and tailored to a specific user environment.

While the various systems employed today for providing customer contact are serviceable, the specific nature of the disparate services offered by various entities make many CRM systems inappropriate for certain applications. For example, a CRM system that is designed for sales organizations that markets consulting-related services is typically not well suited for a company that sells high technology computer systems. While it may be possible to utilize a CRM system that is not easy to configure, it can be a frustrating and time-consuming process. This is particularly the case in those industries where the users of the CRM system are not experts in computer technology. This is a common situation because most sales-related organizations are not staffed by technology experts. Accordingly, without additional improvements in the process methodology for quickly and efficiently targeting and customizing customer communications, the customer communication and retention process may continue to be less efficient than desired and the overall results will most likely continue to be sub-optimal.

### SUMMARY OF THE INVENTION

The apparatus and methods disclosed herein provide a convenient and efficient computer-based process apparatus and methodology for enhancing customer communication and retention opportunities. The most preferred embodiments of the present invention comprise one or more databases comprising:

### BRIEF DESCRIPTION OF THE DRAWINGS

The preferred embodiments of the present invention will hereinafter be described in conjunction with the appended wherein like designations denote like elements and:

FIG. 1 is a block diagram of a computer system and related components for implementing a computer-based CRM mechanism in accordance with a preferred embodiment of the present invention;

FIG. 2 is a block diagram of a server used for implementing a computer-based CRM mechanism in accordance with a preferred embodiment of the present invention;

FIG. 3 is a block diagram of certain components of a computer-based CRM mechanism in accordance with a preferred embodiment of the present invention;

FIG. 4 is a block diagram of the stack used for “role impersonation” in accordance with a CRM mechanism in accordance with a preferred embodiment of the present invention preferred embodiment of the present invention; and

FIG. 5 is schematic representation of a user web page for interfacing with a CRM mechanism in accordance with a preferred embodiment of the present invention.

### DETAILED DESCRIPTION

The most preferred embodiments of the present invention comprise a system and a method for managing and implementing customer/client retention-related communication activities with a high degree of flexibility and customization, making the present invention particularly well-suited for in disparate business environments, as well as government and non-profit environments. Deployed over the Internet, the present invention provides a mechanism for multi-tiered organizations to control and manage the types of communications used by company personnel for customer contact, including marketing and similar campaigns for cross-selling, as well as customer loyalty and retention purposes.

The most preferred embodiments of the present invention are designed to automate communications and interactions between various industry organizations/sales agents and their customers and/or prospects, including in-process contacts with customers and partners, while also offering data analytics, flexible reporting, custom marketing campaigns/activities, relationship building tools, communication effectiveness reporting and enhanced levels of management control and oversight.

After a registration and subscription/service level-setting process, sales agents and companies can transmit data files containing prospects, in-process, completed transaction details including details of their customers, and their business partners and associates. This process can be conducted on periodic pre-determined regular intervals or on an “ad-hoc” basis in real-time, depending on the specific application. After the client or customer data files have been imported, completed transaction data, prospects and in-process communications can be organized and simply added to a database for later use, or assigned to one of a number of automated activity programs.

The system can then be configured to automatically send customized communications (e.g. highly personalized cards and gifts, emails messages, etc.) to the customers for a user controllable period of time. The goals of the various preferred embodiments of the present invention are to keep the company and the company's representatives “fresh” in the customer's mind while ensuring the customer never gets overwhelmed with too many communications. Printed output can contain multiple personalized elements (company logo, sales agent photograph and signature, cross-selling products, tear off referral card with company indicia, legal disclaimers, industry-specific regulatory details (e.g. in the mortgage industry, the banker/broker license details) and may also contain either user-defined copy or professional and pertinent copy from a pre-configured library of customized or customizable content elements.

The user may either follow a wizard to create their own catalog of marketing activities or may opt to simply select from the many timely and pertinent pieces made available to retain or revive client relationships. Customers, prospects, in-process and partners can then be selected (based on data-bound criteria) for a tactical custom campaign.

In addition, the most preferred embodiments of the present invention further comprise complex and substantial support for various organizational preferences that may be based on organizational structure and “inherited” according to a fully configurable hierarchy of users and associated user “roles.” These preferences may include parent company details (e.g. mailing/referral return address, company logo, legal disclaimers, automated program preferences including optional/mandated sales agent elements, per element billing directions and per element pay-as-you-go/pay-up-front billing programs, etc.) that can be “pushed” downward through the organization to sales agents to ensure compliance and consistency of look and message.

The most preferred embodiments of the present invention may be used equally by a human with a PC and a web browser or by another piece of software consuming eXtended Markup Language (“XML”) protocol communications (e.g., Simple Object Access Protocol or “SOAP” web services) for deployment at a CRM-style customer portal. The most preferred embodiments of the present invention may be deployed and used by sales agents, any sized companies (from small independent operations to large international corporate organizations) and 3^{rd} party transaction data aggregators (e.g. Ellie Mae's “Mortgage Connectivity Hub™”), Sophisticated monitoring and audit logging complete with an “impersonation” functionality, allow the various preferred embodiments of the present invention to offer unprecedented oversight and management of sub-ordinate organizations and employees. In summary, the most preferred embodiments of the present invention can be used to streamline the processes of businesses involved in attracting and retaining customers.

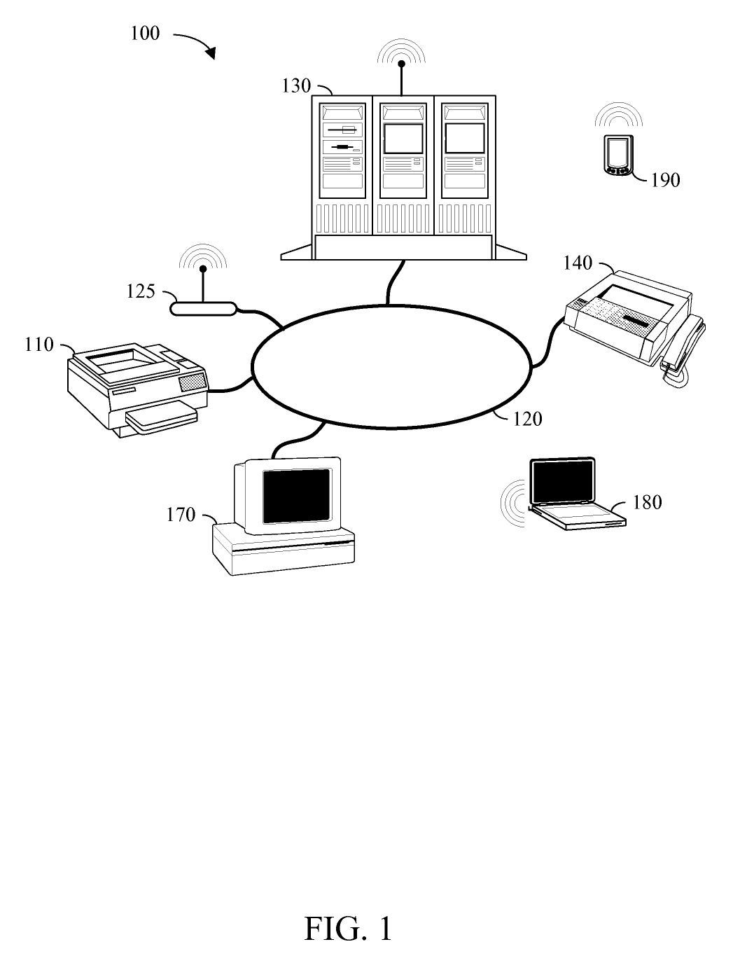

Referring now to FIG. 1, a computer-based CRM system 100 in accordance with a preferred embodiment of the present invention comprises: at least one wireless communication device 125; a data server 130; a desktop computer 170; a laptop computer 180, and a personal digital assistant (“PDA”) 190; all connected or communicatively coupled via a network 120. Additionally, an optional printer 110, and an optional fax machine 140 are shown.

Taken together, the components of computer-based CRM system 100 provide a way for a disparate user base, including program administrators, managers, and clients, to access one or more components or subsystems of CRM system 100 as described herein in conjunction with the various preferred embodiments of the present invention. While the present invention will be described in detail by using various examples, including a typical application suitable for use in conjunction with the mortgage banking industry or similar business operation, those skilled in the art will recognize that the methods and techniques described herein have broad applicability to other environments and applications where quick, efficient, targeted, and customizable customer communication is desirable.

Network 120 is any suitable computer communication link or communication mechanism, including a hardwired connection, an internal or external bus, a connection for telephone access via a modem, standard co-axial cable lines, high-speed T1 line, radio, infrared or other wireless communication methodologies (i.e. “Bluetooth,” infrared (IR), etc.), private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, broadcast cable transmission line, Digital Subscriber Line (DSL), ISDN line, or similar public utility-like access link, including networks connected to the Internet.

In the most preferred embodiments of the present invention, at least a portion of network 120 comprises a standard Internet connection between the various components of computer-based CRM system 100. Network 120 provides for communication between the various components of computer-based CRM system 100 and allows for relevant information to be transmitted from device to device. In this fashion, one or more users of CRM system 100 can quickly and easily gain access to the relevant data and information utilized to search, retrieve, and display information from one or more databases as described in conjunction with the various preferred embodiments of the present invention.

Wireless communication device 125 is communicatively coupled to network 120 and is representative of any wireless communication mechanism that may be used to provide for wireless communication between network 120 and the various devices associated with network 120, including desktop computer 170, laptop computer 180 and PDA 190. Wireless communication device 125 may comprise any type of wireless bridge, wireless router, or similar type of device.

Regardless of the specific components, physical nature, and topology, network 120 serves to logically and communicatively link or couple the physical components of computer-based CRM system 100 together, regardless of their physical proximity, thereby enabling communication between the various components. This is especially important because in many preferred embodiments of the present invention, data server 130, desktop computer 170, and laptop computer 180 may be geographically remote and/or physically separated from each other.

Data server 130 represents a relatively powerful computer system that is made available to desktop computer 170, laptop computer 180, and/or PDA 190 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 130. Data server 130 may also provide various additional software components (not shown this FIG.) such as database servers, web servers, firewalls, security software, and the like. The use of these various standard hardware and software components is well known to those skilled in the art.

Given the relative advances in the state-of-the-art computer systems available today, it is anticipated that functions of data server 130 may be provided by many standard, readily available data servers. This may also include the deployment of multiple inter-connected and redundant data servers 130 to enhance the availability and reliability of the functions provided by data server 130. Depending on the desired size and relative power required for data server 130, storage area network (SAN) technology may also be deployed in certain preferred embodiments of the present invention. Additionally, various biometric and identification verification devices for identifying users and controlling access as well as creating and verifying digital signatures (i.e., electronic signature processing) may also be included.

Desktop computer 170 and laptop computer 180 may be any type of computer system known to those skilled in the art that is capable of being configured for use with CRM system 100 as described herein. This includes various levels of desktop computers, tablet computers, laptop computers, pen-based computers and the like. Additionally, handheld and palmtop devices, such as PDA 190, are also specifically included within the description of devices that may be deployed as a companion to or in lieu of computer system 170. It should be noted that no specific operating system or hardware platform is excluded and it is anticipated that many different hardware and software platforms may be configured to create computer system 170. As previously explained in conjunction with data server 130, various hardware components and software components (not shown this FIG.) known to those skilled in the art may be used in conjunction with computer system 170. It should be noted that in the most preferred embodiments of the present invention, desktop computer 170 is linked (via wired or wireless connection) to its own LAN or WAN and has access to its own data server (not shown this FIG.).

Personal digital assistant (PDA) 190 is representative of a class of devices that are at least somewhat less full-featured and less powerful than computers 170 and 180. This includes, for example, Windows mobile OS devices, Palm OS devices, Pocket PC devices, and various types of “smart phones” (e.g., the Apple iPhone, Palm Pre, or Google Android). Those skilled in the art will recognize these various devices and others that are suitable for deployment as PDA 190. While somewhat less powerful than computers 170 and 180, PDA 190 is also configured to communicate with data server 130 via network 120 to send and retrieve client communications and related information to and from data server 130. Given the standard functionality for devices that may be deployed as PDA 190, this communication will typically be a wireless Internet connection (e.g. “wi-fi” or “wi-max”), a GSM or other telephone communication, and/or a Bluetooth connection. One example of the use for PDA 190 in the context of CRM system 100 would be a data collection activity by a sales representative conducting off-site visits to prospective clients with the resulting information being collected and stored in a database on data server 130 for later use or access in conjunction with one or more CRM or client contact programs.

In general, the communication between devices associated with data server 130 will be requests for entering data into or retrieving data from one or more databases located on data server 130. The users of desktop computer 170 and/or laptop computer 180 may be program administrators, managers and/or prospective clients who are seeking to make determinations regarding program eligibility and related activities. Additionally, various related service providers such as government agencies, banks, insurance companies, mortgage companies, benefits administrators, and their employers and agents may also have access to one or more databases located on data server 130 via desktop computer 170 and/or laptop computer 180. A typical transaction may be represented by a request for a benefits eligibility determination for a prospective client. In this case, a request to access the prospective client's data file is sent from desktop computer 170 and/or laptop computer 180 to data server 130.

Upon receipt of a valid request, data server 130 processes the request to access one or more databases containing the relevant information and takes the specific action requested by desktop computer 170 and/or laptop computer 180, typically by retrieving and returning the requested data to desktop computer 170 and/or laptop computer 180. The request may be directed towards locating a specific item in a database, comparing one or more items in the database, obtaining additional information from a database about one or more prospective clients, determining and calculating benefits eligibility, or other similar requests.

It should be noted that while FIG. 1 shows only a single desktop computer 170 and a single laptop computer 180, it is anticipated that the most preferred embodiments of the present invention will comprise dozens and even hundreds of computer systems 170 and laptop computers 180. Each of these computers 170 and 180 will be configured to access data server 130 in an appropriately secure way so as to accomplish the specific objectives of the user of the desktop computer 170 or laptop computer 180. For example, the service provider that controls the databases stored on data server 130 may utilize desktop computer 170 or laptop computer 180 to access data server 130 and create or modify a given database. An insurance provider, located in a remote location, may use desktop computer 170 or laptop computer 180 to access data server 130 to retrieve information about benefits for one or more clients that are stored in a database stored on data server 130, etc.

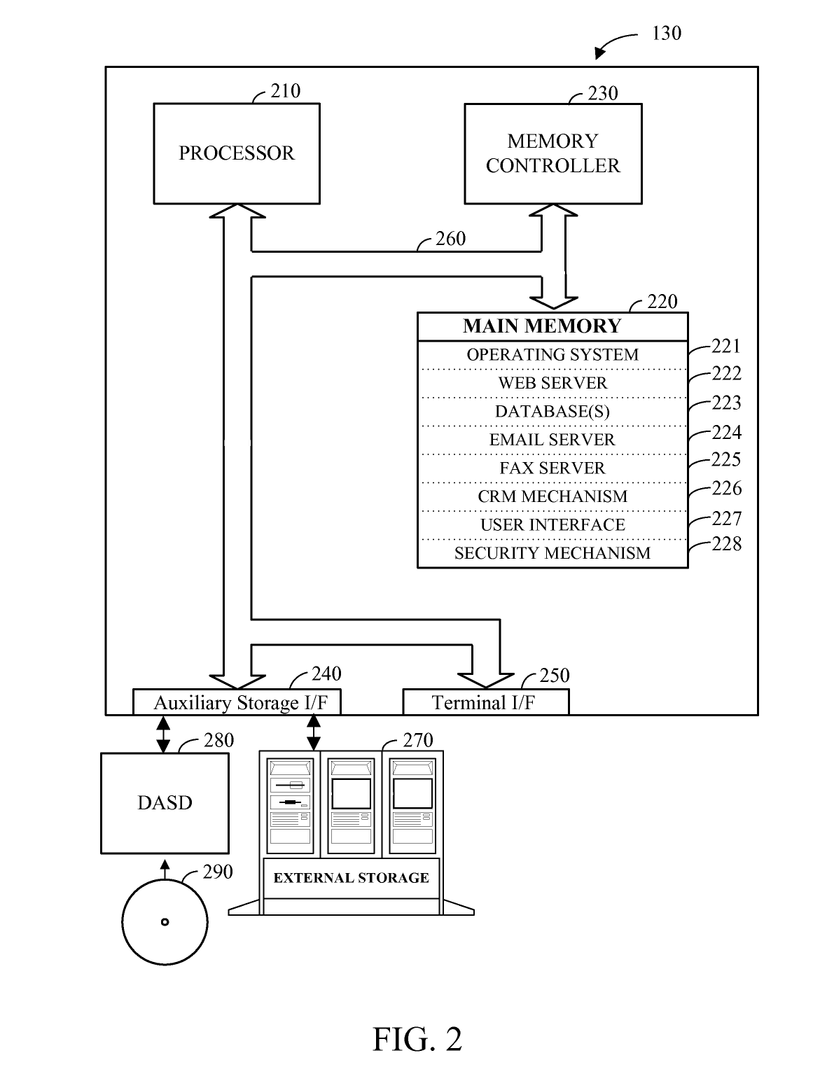

In the most preferred embodiments of the present invention, multiple desktop computers 170 and multiple laptop computers 180 will all be configured to communicate simultaneously with data server 130 and with each other via network 120. In addition, the most preferred embodiments of the present invention include an Application Service Provider (ASP) or Software as a Service (“SaaS”) environment where data server 130 is operated as a clearinghouse in a hosted operation. In this fashion, multiple desktop computers 170 and laptop computers 180 will have access to data server 130 and the databases stored thereon via a global computer network such as the Internet. Data server 130 is further described below in conjunction with FIG. 2 below.

Optional printer 110 and an optional fax machine 140 are standard peripheral devices that may be used for transmitting or outputting paper-based documents, notes, transaction details, reports, etc. in conjunction with the various requests and transactions processed by CRM system 100. Optional printer 110 and an optional fax machine 140 may be directly connected to network 120 or indirectly connected to network 120 via any or all of desktop computers 170, laptop computers 180, and/or data server 130. In the most preferred embodiments of the present invention, printer 110 will comprise one or more high speed high quality color printers configured to print all manner of marketing and customer retention collateral. Finally, it should be noted that optional printer 110 and optional fax machine 140 are merely representative of the many types of peripherals that may be utilized in conjunction with CRM system 100. It is anticipated that other similar peripheral devices will be deployed in the various preferred embodiment of the present invention and no such device is excluded by its omission in FIG. 1.

Those skilled in the art will recognize that FIG. 1 depicts a fairly standard arrangement where data server 130 is considered to be a server and computers 170 and 180 are considered to be clients of data server 130. Additionally, those skilled in the art will recognize that the functionality of data server 130 may be deployed on either of computers systems 170 and 180 in a more traditional “stand-alone” environment. In either case, the methods of the present invention are designed to minimize the amount of data that must be transferred from a database to the user of CRM system 100.

Referring now to FIG. 2, data server 130 of FIG. 1 in accordance with a preferred embodiment of the present invention represents one of many commercially available computer systems. However, those skilled in the art will appreciate that the methods and apparatus of the present invention apply equally to any computer system, regardless of the specific operating system and regardless of whether the computer system is a traditional “mainframe” computer, a complicated multi-user computing apparatus or a single user device such as a personal computer or workstation.

Data server 130 most suitably comprises at least one Central Processing Unit (CPU) or processor 210, a main memory 220, a memory controller 230, an auxiliary storage interface 240, and a terminal interface 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the more salient features of data server 130.

Processor 210 performs computation and control functions of data server 130, and most preferably comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor or CPU. Processor 210 suitably executes one or more software programs contained within main memory 220.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a DVD or CD-ROM drive that may read programs and data from a DVD or CD disk 290.

It is important to note that while the present invention has been (and will continue to be) described in the context of a fully functional computer system with certain application software, those skilled in the art will appreciate that the various software mechanisms of the present invention are capable of being distributed in conjunction with tangible signal bearing media as one or more program products in a variety of forms, and that the various preferred embodiments of the present invention applies equally regardless of the particular type or location of signal bearing media used to actually carry out the distribution. Examples of signal bearing media include: recordable type media such as DVD and CD ROMS disks (e.g., disk 290), and transmission type media such as digital and analog communication links, including wireless communication links.

Various preferred embodiments of the program product may be configured to: create and modify multiple databases; track, update and store information for a plurality of sales agents, clients and prospective clients, participants in various industries such as banking and insurance, benefits coordinators, government officials, healthcare providers, and healthcare facilities; configure and implement various search and retrieve functions for a multitude of communication programs, including search requests and program configurations made by users of system 100; track and store information about various programs and communication options; update and transmit search results to one or more users; and provide one or more user interfaces for accomplishing all of these functions. In this fashion, the appropriate entities (i.e., administrators, sales agents, clients, managers, etc.) can utilize the program product to initiate and complete a wide variety of communications applications as set forth herein. Similarly, a program product in accordance with one or more preferred embodiments of the present invention can also be configured to perform substantially all of the steps depicted and described in conjunction with the figures below for implementing a CRM system.

Memory controller 230, through use of an auxiliary processor (not shown) separate from processor 210, is responsible for moving requested information from main memory 220 and/or through auxiliary storage interface 240 to processor 210. While for the purposes of explanation, memory controller 230 is shown as a separate entity; those skilled in the art understand that, in practice, portions of the function provided by memory controller 230 may actually reside in the circuitry associated with processor 210, main memory 220, and/or auxiliary storage interface 240.

Terminal interface 250 allows users, managers, system administrators, and/or computer programmers to communicate with data server 130, normally through separate workstations or through stand-alone computer systems such as computer systems 170 and computer systems 180 of FIG. 1. Although data server 130 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be used.

Main memory 220 suitably contains an operating system 221, a web server 222, one or more databases 223, an email server 224, a fax server 225, a CRM mechanism 226, a user interface 227, and a security mechanism 228 residing in main memory 220 and being executed by processor 210. CRM mechanism 226 may also comprise a rules engine and workflow model to assist with the overall flow of data storage, retrieval, and processing. The term “memory” as used herein refers to any storage location in the virtual memory space of data server 130.

It should be understood that main memory 220 might not necessarily contain all parts of all components shown. For example, portions of operating system 221 may be loaded into an instruction cache (not shown) for processor 210 to execute, while other files may well be stored on magnetic or optical disk storage devices (not shown). In addition, although database 223 is shown to reside in the same memory location as operating system 221, it is to be understood that main memory 220 may consist of multiple disparate memory locations. It should also be noted that any and all of the individual components shown in main memory 220 might be combined in various forms and distributed as a stand-alone program product on a CD or DVD.

Operating system 221 includes the software that is used to operate and control data server 130. In general, processor 210 typically executes operating system 221. Operating system 221 may be a single program or, alternatively, a collection of multiple programs that act in concert to perform the functions of an operating system. Any operating system now known to those skilled in the art or later developed may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate and possibly redundant hardware and software systems. This configuration provides additional robustness for system uptime and reliability purposes. Regardless of the specific form of implementation, Web server 222 provides access, including a user interface, to allow individuals and entities to interact with web portal application 224, including via network 120 of FIG. 1.

Database 223 is representative of any suitable database known to those skilled in the art. In the most preferred embodiments of the present invention, database 223 is a Structured Query Language (SQL) compatible database file capable of storing information relative to various items that may be of interest to the users of CRM system 100 of FIG. 1. In the most preferred embodiments of the present invention, database 223 will comprise a collection of information about one or more contacts (with a contact being defined as potential participants, customers, clients, etc.) along with the contact attributes and specific situation/circumstances as well as providing for the tracking and management of multiple programs, programs requirements, procedures and protocols that may be used to provide various services to the prospective contacts or program participants.

In the most preferred embodiments of the present invention, database 223 comprises multiple databases that may be used by different components to store, retrieve, and manage various information elements in conjunction with the operation of CRM system 100 of FIG. 1. For example, database 223 may contain a user database, containing all of the relevant information for each user of CRM system 100 of FIG. 1, including their roles, job description, and rights within CRM system 100 of FIG. 1. Similarly, a company database may be another set of data configured within database 223. Additionally, security access provisions, restrictions, and permissions for each user may also be considered as a database contained within database 223. Another important use of database 223 may be the storage of various graphic images (e.g., logos, photographs, etc.) that may be accessed by the users of CRM system 100 of FIG. 1 in conjunction with the preparation and deployment of certain marketing and customer loyalty programs.

Those skilled in the art will recognize that other types of information for other types of data that may be used in other applications (e.g., historical, informational, technical, etc.) may be stored and retrieved as well. While database 223 is shown to be residing in main memory 220, it should be noted that database 223 may also be physically stored in a location other than main memory 220. For example, database 223 may be stored on external storage device 270 or DASD 280 and coupled to data server 130 via auxiliary storage I/F 240. Additionally, as discussed above, while shown as a single database 223, those skilled in the art will recognize that database 223 may be a single monolithic database or actually comprise a series of related databases, logically linked together. Depending on the specific application and design parameters, database 223 may take many different forms when implemented.

While not required, the most preferred embodiments of data server 130 of FIG. 1 will typically include an email server 224. E-mail server 224 is any email server application capable of being configured and used to send and receive various status messages and updates to data server 130 and between computers 170, 180, and/or 190 of FIG. 1 via email, as may be necessary to enhance the overall process of completing various indexing, search-and-retrieve and/or eligibility determination transactions described herein. This includes the generation of automated email messages relating to the tracking and management of various programs as well as informational messages related to prospective clients and the status of CRM system 100 of FIG. 1. Automated e-mail messages are also generated to provide notifications regarding the status of user accounts as well as other information for related to the programs and prospective participants in accordance with the preferred embodiments of the present invention.

Optional fax server 225 is any fax server known to those skilled in the art and is configured to receive inbound fax messages and to transmit outbound fax messages. Fax server 225 may format and transmit any data processed by CRM system 100 of FIG. 1 and make it available for use by any other component of CRM system 100 of FIG. 1. Additionally, fax server 225 may process the data received and send it directly to web server 222 and make the incoming data available for further processing by CRM system 100.

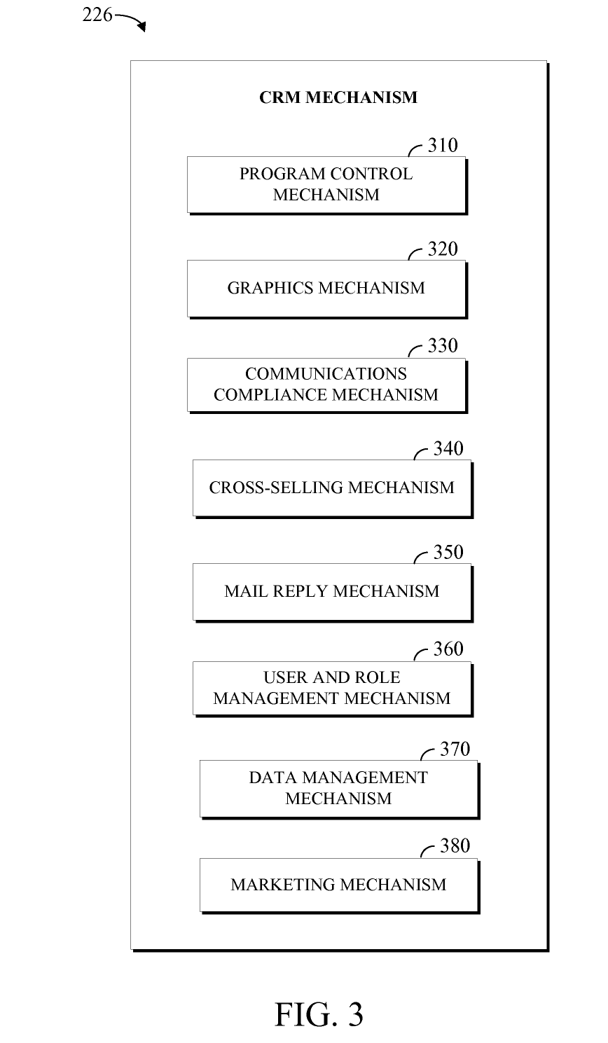

CRM mechanism 226 is a software mechanism executed by processor 210 and provides the functional operational aspects of CRM system 100 of FIG. 1. Additional details regarding CRM mechanism 226 are presented below in conjunction with FIG. 3.

User interface 227 provides a way for a user to access the various features and functions of CRM system 100 of FIG. 1. In the most preferred embodiments of the present invention, user interface 227 will be configured for deployment as a web client to be used in conjunction with web server 222. In this fashion, any standard web browser (e.g., Safari, Firefox, Internet Explorer, etc.) may be used to access CRM system 100 of FIG. 1.

The most preferred embodiments of the present invention will also include a security and/or encryption mechanism 228 for verifying access to the data and information contained in and transmitted by data server 130. Security mechanism 228 may be incorporated into operating system 221 and/or web server 222. Additionally, security mechanism 228 may also provide encryption capabilities for other components of CRM system 100 of FIG. 1, thereby enhancing the robustness of CRM system 100. Security mechanism 228 is most preferably configured to protect the integrity and security of the information transmitted via network 120 of FIG. 1. Given the present levels of concern for and restrictions on unauthorized communications set forth by laws such as the Controlling the Assault of Non-Solicited Pornography and Marketing Act of 2003 (“CAN-SPAM Act), the National Do-Not-Call Registry, and similar state, local, and national directives regarding communication restrictions, the function of security mechanism 228 may also be important for compliance issues and to ensure that all communications are authorized and appropriate.

Once again, depending on the type and quantity of information stored in database 223 and security mechanism 228 may provide different levels of security and/or encryption for different computer systems 170 and 180 of FIG. 1. Additionally, the level and type of security measures applied by security mechanism 228 may be determined by the identity or “role” of the end-user and/or the nature of a given request and/or response. In some preferred embodiments of the present invention, security mechanism 228 may be contained in or implemented in conjunction with certain hardware components (not shown this FIG.) such as hardware-based firewalls, switches, dongles, and the like.

In the most preferred embodiments of the present invention, the various components of CRM system 100 of FIG. 1 are able to communicate using multiple communication protocols, including HyperText Markup Language (HTML), SOAP, XML, and others. Those skilled in the art will recognize that the communication protocols used herein may be readily adapted and configured to allow for the rapid and efficient transmission and receipt of data by and between the various components of CRM system 100 of FIG. 1. This would also include the ability to customize the input and output of CRM system 100 of FIG. 1 for integration with other systems. The use of XML and similar electronic communication protocols in general is well known to those skilled in the art.

Referring now to FIG. 3, a block diagram representing the functionality of CRM mechanism 226 of CRM system 100 of FIG. 1 is depicted. As shown in FIG. 3, the most preferred embodiments of CRM mechanism 226 will comprise: a program control mechanism 310; a graphics mechanism 320; a communications compliance mechanism 330; a cross-selling mechanism 340; a mail reply mechanism 350; a user and role management mechanism 360; a data management mechanism 370; and a marketing mechanism 380.

Program control mechanism 310 comprises a mechanism for creating, invoking, and/or managing series of automated activity programs including collections of stock (e.g., pre-defined) or user-defined activities with prescribed, data-bound or offset production and associated delivery dates. An “activity” is simply a term for a specific user directed “communication” with a client, prospective client, customer, etc. An activity may comprise an email message, a gift package, a greeting card, a formal letter, etc. An activity program is a collection of activities that are delivered to the customer or client at the prescribed time and in the prescribed manner.

A user of CRM system 100 of FIG. 1 can access program control mechanism 310 via user interface 227 of FIG. 2 to create, select, customize, modify, delete, or implement one or more automated activity programs, as desired. These automated activity programs may be directed towards specific marketing campaigns or customer retention campaigns. Each activity has a unit price, a shipping price, billing scheme (e.g., pay-as-you-go or pay-up-front) and billing contact information that provides an indication of which company or sales agent is to be billed for the selected activity program. This allows for centralized or decentralized billing, for any amount or type of output, to any level within the organization.

In addition, programs and program elements available to a user of CRM system 100 of FIG. 1 via program control mechanism 310 can be determined, manipulated, and/or controlled by a supervisory level user (e.g., a user's immediate supervisor or manager at a corporate entity) and those selected programs and activities are pushed down to subordinate branch offices and any sales agents therein. Corporate entities can also specify permitted, optional activities thus providing the sales agents with various activity program options they can choose for adoption, if desired. A corporate entity may not wish to mandate any specific activity program or programs but may simply indicate which programs are available for use by a sales agent. Additionally, based on the hierarchy of the company or organization, billing policies and payment procedures for any selected activity programs created by subordinate entities may be billed to corporate headquarters, the district or branch office, or directly to the sales agent, thereby providing for maximum flexibility in the payment process.

The corporate office may decide to allow sales agents to only use pre-determined activity programs, which may be selected via user interface 227 of FIG. 2. Additionally, corporate entities can determine and control whether or not subordinate branch offices are able to create custom activity programs, which can be offered to that branch's sales agents, and both corporate and branch entities can determine or control whether or not sales agents are able to create their own programs. Basically, the decisions made at the highest level are “inherited” by each lower level, with each lower level being able to further restrict, but not expand, the type and quantity of activity programs available via program control mechanism 310. In this type of hierarchal system, the flexibility that can be offered provides for the optimal level of communications to be made, as determined by the appropriate decision-makers in the company.

In at least one preferred embodiment of the present invention, a company or a sales agent, given appropriate permissions, may create their own custom marketing activities and construct automated activity programs from those custom marketing activities. Once created, these custom activity programs may be configured for use by other sales agents, in the same fashion as stock automated activity programs are configured and provided for use via program control mechanism 310.

Graphics mechanism 320 is a mechanism provided to control the use of graphics within one or more activity programs, if printed output is to be incorporated. Recognizing the importance of consistency for a company's brand in marketing activities, it may be desirable to control the types and content of the images utilized in a given activity program or for any other purpose. Graphics mechanism 320 provides a way to select, approve, and include various graphical images (e.g., logos, pictures, etc.) in a customer communication. CRM system 100 of FIG. 1, via graphics mechanism 320, can take an image from a stored location, such as database 223 of FIG. 2, and have that image appear on all printed output and, where desired, physical products such as gift tins and similar goods. Standardized or approved graphic images can be provided by a corporate entity and these images will be used in all communications generated by all subordinate branches and sales agents. As explained above in conjunction with program control mechanism 310, a company may allow subordinate organizational units to provide their own logo to be used by them and their sub-ordinate branch officers and sales agents. If no company above a sales agent provides an image, the printed output may be adapted to provide company details in place of a graphical image on all printed output.

Communications compliance mechanism 330 is provided to enhance corporate compliance with communication requirements imposed by various governmental and regulatory agencies and their associated regulations. For example, for the mortgage industry, it may be necessary to ensure that a Banker/Broker License number and a legal disclaimer (one for each state or zip-code group, or a location-independent default) is specified and used in all printed output. Similarly, for law firms, many state bar associations require the inclusion of certain language on all marketing communications. Failure to abide by the restrictions and mandates of the governing authority can lead to serious repercussions. Since this is a user-configurable element, it is possible to ensure that each activity program approved for use by a sales agent is pre-configured with the necessary elements to ensure compliance.

In the most preferred embodiments of the present invention, communications compliance mechanism 330 will be configured to programmatically interface with a database such as database 223 or some external database to verify the address and contact status of each potential customer, actual customer or other intended recipient of a planned activity or communication so as to ensure that all selected and intended recipients are cleared for contact or participation in the selected activity or marketing campaign. In this fashion, it will be possible to minimize or eliminate contacting or otherwise communicating with individuals that have established a do-not-contact preference via CRM system 100 of FIG. 1 or with an outside agency or organization. These preferences can be stored in database 223 of FIG. 2 and updated on a periodic or as-needed basis, including real-time screening at the time a marketing campaign or activity program is created and/or updated.

The specific details for communication compliance can be provided individually or collectively at the corporate level and at any of the subordinate company levels. Higher levels may determine whether or not lower levels are allowed to override the details with their own. While the most common use will be for the inclusion of specific messages according to geographic locations, other discriminating characteristics may be selected. For example, certain messages may need to include certain information based on the demographics of the intended recipient (e.g., age or sex, etc.).

Regardless of the specific determination, communications compliance mechanism 330 provides for demographic, national, regional, state, county and even zip code specific language or disclaimers to be submitted and used based on the location of the intended recipient of the communication for any activity program, thus ensuring regulatory compliance regardless of where the intended recipient is physically located. The corporate entity can provide appropriate details and may also prevent any subordinate organization in the hierarchy from overriding the pre-selected details, thus enforcing the same details in all printed output. Alternatively they may offer this feature to subordinate organizations to accommodate differing brands and corporate identities.

Cross-selling mechanism 340 is provided to allow for the inclusion of other products and services to be offered in a given marketing campaign or activity program. For example, a company may enter into a partnership with another entity and receive a commission from that entity for selling certain products or services on behalf of that entity. These products and services can be selected and identified at the highest corporate level and then pushed down to all subordinate organizations and sales agents. Alternatively, the corporate level may delegate the selection and promotion of cross-selling products down to the appropriate subordinate organizations and sales agents. At each level, subordinate organizations and sales agents can be prohibited from overriding the prescribed cross-selling products or permitted to select from a group of pre-approved products or services. CRM mechanism 226 of FIG. 2, via cross-selling mechanism 340, may be configured to search from the sales agent role level upwards through the organizational hierarchy until it finds an approved set of products and services to include in the selected program or campaign on output. If no specific products and services are provided, a default set may be provided and used or, alternatively, the cross-selling of products and services may be excluded from consideration.

Where the cross-selling of products and services is included in a campaign or activity program, the details may be incorporated into printed materials as part of a “tear-off and return” card that lists cross-selling products and services that can be printed on the selected output. For example, the products and services may appear as a check box list of product names, in the selected language of the recipient (they will be detailed in English if no alternative language copy is provided) with an appropriate return address printed on the reverse side.

The recipient may simply check the appropriate box for anything they are interested in hearing more about, tear off that portion of the printed piece and put it in the mail. Embedded tracking information on the tear off portion allows the company or sales agents to track which recipient received the original communication, thereby providing feedback on the effectiveness of the cross-selling campaign. Alternatively, there may be a special code or link embedded in an email message. When the recipient replies to the email, requesting additional information, the source of the email, along with the details of the response, can be captured for use in supplying the requested information, tracking the source of the referral, and evaluating the effectiveness of the campaign.

Mail reply mechanism 350 provides additional functionality for communication with the prospect or customer with regards to certain communications. Mail reply mechanism 350 offers support for both courtesy reply mail and business reply mail methodologies. Both approaches require a return address for any replies that the marketing campaign or activity program may generate (e.g., requests for products and services, including cross-selling of third party products and services). The desired return address, whether a physical mailing address or an email return address, can be set at a corporate company level or at the branch offices. Each level of the corporate hierarchy has the ability to prohibit overriding the pre-determined or default address by any subordinate level organizations in the corporate hierarchy. Then, when the specific communication missives are transmitted to the intended recipients, the appropriate address for return communications will appear. Specifying and controlling the response address at the corporate level allows for centralized response tracking.

User and role management mechanism 360 provides a significant improvement over presently known CRM systems. Each user, when given access to CRM system 100 of FIG. 1, is assigned one or more “roles” that corresponds to their job function. Each “role” defines a specific set of permissions within CRM system 100 of FIG. 1 that defines which features and functions of CRM system 100 of FIG. 1 the user can access. For example, in a typical sales organization, the following roles may be defined; Sales Agent; Branch Manager; Company Manager; Billing Contact; Transaction Data Contact; Reports Contact; etc. The role for each user can be configured and assigned based on the identity of the user and then detected based on some unique identifying characteristic of the user (e.g., e-mail address). Once the role or roles have been assigned, the user will only be able to access the functions and information in CRM system 100 of FIG. 1 that are associated with their assigned role. While this feature can be deployed in conjunction with security mechanism 228, it also allows for “role impersonation” to be implemented. Role impersonation is explained in greater detail below.

It's entirely possible for one user to fulfill multiple roles within a given organization. In this case, the user may be assigned a role for Sales Agent and another role for Company Manager (the permissions super-set of Billing, Transaction Data and Reports Contact). Then, when the user wants to access CRM system 100 of FIG. 1, they will be presented with a list of roles that they may select from at the time of login and they will have the appropriate permissions enabled for that session. If the user logs into the system again and selects a different role, the permissions for that role will be enabled.

Where a user only has one role assigned, they will not be presented with a choice of roles during the login process and the one existing role will be assumed and used. It is also entirely possible for a Sales Agent to be registered in CRM system 100 of FIG. 1 by multiple companies. In this case the user is presented the collection of roles at login. Once logged in, their data will be partitioned such that the user will only see the data belonging to the Sales Agent role at their respective company associate with their login identity. To see the data belonging to their other Sales Agent role, they must either log back in with that role or use a “fast role” switch feature at the top of the home page to change their current system role.

CRM system 100 of FIG. 1 has default roles and associated permissions for all supported user or entity types, however, individual organizations may wish to construct their own roles with user-definable permissions. They are bound by the same detection rules; however, the permissions for those user defined roles can be set on a per-company basis. Where alternative role profiles exist, all subordinate organizations and sales agents will “inherit” or receive the prescribed set of permissions. The ability for subordinate organizations to change their role profiles can be prohibited at any company level in the corporate hierarchy.

In addition to the major system roles clients can create their own users for ancillary individuals in their organization (e.g., personal assistants, interns, etc). CRM system 100 of FIG. 1 also supports the notion of delegation of roles. For example, if user A has been granted permission to a given function by virtue of their assigned role, that permission can also carry a flag indicating whether or not it can be delegated to another user.

If the delegation flag is set to “yes,” user A can (with appropriate permissions) create a new user B and delegate that permission (along with the associated permissions) to the new user B. User B is then free to log into the system and use the delegated functions as if user A were logged into CRM system 100 of FIG. 1 and executing those functions. User A maintains full control over the activities and delegations to user B and user B can be disabled or deleted by user A at any time. Should user A get disabled or deleted, user B and their permissions will also be automatically disabled or deleted by CRM system 100 of FIG. 1. Also, users and permissions carry an expiration date that can be configured to allow for automatic disabling of users and permissions at a specified future point in time.

A delegated permission may or may not be delegated further (i.e. user B may [with appropriate permissions] be able to create new user C, but user B′s permissions cannot automatically be further delegated to user C unless specifically allowed by the user that delegated the permissions to user B. The ability to create users, create roles and delegate permissions is another preference that can be permitted, prohibited and controlled at any organizational level within CRM system 100 of FIG. 1.

Data management mechanism 370 may be used to import and export data to and from CRM system 100 of FIG. 1. Accessing data management mechanism 370 via user interface 227, a user may identify and specify the method and data format of transaction data files to be submitted from an existing transaction processing systems that are to be imported into CRM system 100 of FIG. 1. These import parameters can be pre-defined at any company or sales agent level, depending upon where the transaction data is being submitted from and depending on the permissions granted for the specific user by security mechanism 228 of CRM system 100 of FIG. 1.

Data management mechanism 370 can also support client-specific field mappings, thereby providing support for report data exported from existing transaction processing systems. After an initial submission, the custom field mappings may be created and subsequent submissions from the transaction processing system will be automatically imported into CRM system 100 of FIG. 1 in accordance with the user-specified field mappings. Where the structure of the submitted data is implicit, mutually understood and enforced (e.g. for Mortgage Industry Standards Maintenance Organization “MISMO” documents and application program interface “API” submissions) the data may be automatically imported without user intervention.

The transactions imported into CRM system 100 of FIG. 1 via data management mechanism 370 may then be processed by an importation and rules engine associated with data management mechanism 370. The imported elements adhere to any ownership details embedded within the data (e.g. a corporate entity may submit data centrally, but may include a branch or sales agent id to associate with a given transaction or transactions). The imported transaction data may also contain specific identification parameters specifying which automated activity program the transaction is to be associated with. There may also be data-bound criteria supplied with the imported transactions to help associate the transaction with an appropriate marketing campaign or activity program (e.g. if loan amount >$1,000,000 direct to “high value client” program, etc.). Duplicate and repeat customers may also be detected and flagged for later user attention as necessary.

Once the desired transaction have been imported into CRM system 100 of FIG. 1 via data management mechanism 370, a notification may be sent to the owner of the batch of imported transactions to draw attention to any actions that need to be taken relative to the imported data and associated transactions. The user is then able to log into CRM system 100 of FIG. 1 and tend to any outstanding issues via user interface 227 of FIG. 2.

The rules and importer logic are user-definable and although defaults exist, a user is free to define their own importation rules to implement their particular marketing strategy. These rules are, once again, settable at a company level and subordinate organizations may be permitted or prohibited from overriding them.

Once a transaction has been imported and is free of identifiable issues, it awaits activation by the user. The most preferred embodiments of the present invention comprise an activation preference, specifying the number of business days after importing the transaction data into CRM system 100 of FIG. 1 that the user has to review the assumed actions before the transaction is activated and output is scheduled and created. During this time the user can change any and all details about the particular transaction and the program (or lack of). If no action is required and no issues exist, the transaction will automatically become active. Activation preferences are settable at the corporate level and at all branches and sales agents. As previously explained in conjunction with other features, branches and sales agents can be permitted or prohibited from changing the activation preferences.

Marketing mechanism 380 is provided to further enhance the functionality of CRM system 100 of FIG. 1 by providing additional user control over certain aspects of marketing campaigns and activity programs for the creation of centralized marketing strategies. A corporate entity, branch office or sales agent may create marketing activities and organize them into user-defined categories in various catalogs (e.g., Prospect, In-Process, Customer, Partner, etc.). A corporate office or an office with at least one branch may further apply permissions to certain activity categories.

For instance, a corporate entity may define a collection of marketing activities and organize them into geographical categories. Then, it would be possible to select a category and define which branch offices are permitted and/or prohibited from seeing and/or using the activities in that category, and what the default permission should be for newly registered branches (e.g., allow or deny access). The corporate entity may also specify whether particular activities can be copied and: a) used as is; or b) changed and used with permission. This allows users of the corporate catalog to crate a copy of a pre-defined activity and if permitted, make changes to tailor to their specific needs, then with or without permission the activity can be used in a campaign. Access to the various catalogs and the categories of activities therein can be controlled by the client, exposing only prescribed marketing activities to authorized parts of the organization while preventing unauthorized activities from being created and used.

For many software applications, such as CRM System 100 of FIG. 1, it is typically desirable to provide certain types of “drill-down” functionality for specific interrogation, management, and roll-up reporting systems for multi-tiered corporate organizations. This type of functionality allows different users to have access to different levels and layers of information within the system. In the past, the software design often included one or more contrived means to ensure that the correct user is given access to only the things that they should have access to while providing some type of flexibility for viewing other aspects of the system. In many cases, this would mean the provision of multiple passwords and multiple user login representations for various views of the application and the application data. Each user could access the system using a different set of codes to access different areas of the system. This approach, while functional, is far from efficient and may provide opportunity for system misuse. CRM System 100 of FIG. 1 incorporates a novel method to provide this form of application capability and security through the implementation of “role impersonation.”

Another novel feature of CRM system 100 of FIG. 1 is the concept of role impersonation. As previously discussed, a role is a collection of permissions. These permissions manifest themselves in a variety of ways within CRM system 100 of FIG. 1, but most notably in the group and function menus offered at the top of every page rendered via user interface 227 of FIG. 2. When a user logs in, they are presented their roles (if one role is available, that is assumed), a role is selected and the user is logged into the system. This results in the creation of a Current User object configured with all of the important details about the role and the company it belongs to. The home page and all other pages rendered by user interface 227 of FIG. 2 are programmatically aware of the Current User object and adapt the functions and information presented to the user based on their assumed role (e.g., Sales Agent, Manager of an organizational unit, or Ancillary User).

In a broader sense, “roles” also represent a form of “data aggregation ” or scope of data that may be presented to a user. In conjunction with each specific role, a user may get new permissions (which gives the user access to various application pages and functions) by selecting a different role, but those permissions will only present data from database 223 of FIG. 2 that are consistent with and constrained by the selected role's data aggregation scope (e.g. Corporate Manager role will have access to all Branch Offices [or a subset thereof] and all subordinate Sales Agent data, a Branch Manager role will have access to only the subordinate Sales Agent data, and a Sales Agent will only have access to their own data.) This functionality enforces logical data partitioning between various roles and the companies that the various roles are linked to. In this fashion, a manager will see report elements that are company specific and automatically roll-up subordinate organization and sales agent data, and provide drill-down interrogation whereas, a sales agent will see only their personal data and results, without being able to access higher level data.

Particular roles can contain role-specific permissions. A corporate manager role will typically have access to a list of their sub\ordinate organizational units and a branch manager role will have access to a list of their sales agents. Selecting a branch office will display the available users and sales agents within that branch and further selecting one of the displayed results will cause impersonation of that user's role. Likewise, a branch manager can select a user role or sales agent within their list of subordinates to impersonate.

Impersonation results in a new Current User object being created and populated with the selected user role's details and permissions. The previous Current User object is pushed onto the impersonated user (First-In, Last-Out “FILO”) stack within the new Current User object. The new Current User object is stored in the user's session and the user is directed to the home page. All page elements and menus rendered by user interface 227 of FIG. 2 will be changed to display the new Current User's permissions and context. This all occurs without the actual user being required to log into or out of CRM system 100 of FIG. 1.

An impersonating user will see a portion of the screen display indicating the option to “go back” “to {previous user name}” in place of the standard “Logout” indicia typically displayed on every page when a user is not involved in impersonation. Clicking on the “go back” indicia will result in the new Current User object becoming the last added object on the impersonation stack. The updated Current User is then saved in the user's session and the user is directed to the home page.

When all impersonation objects have been eliminated from the stack, the user is no longer impersonating any user and they will see the “Logout” indicia appear on every page and, clicking on this indicia will result in the Current User being destroyed and the logout command will be confirmed and executed. There are no programmatic limits to the number of impersonations that can take place and safeguards exist to prevent impersonation loops.

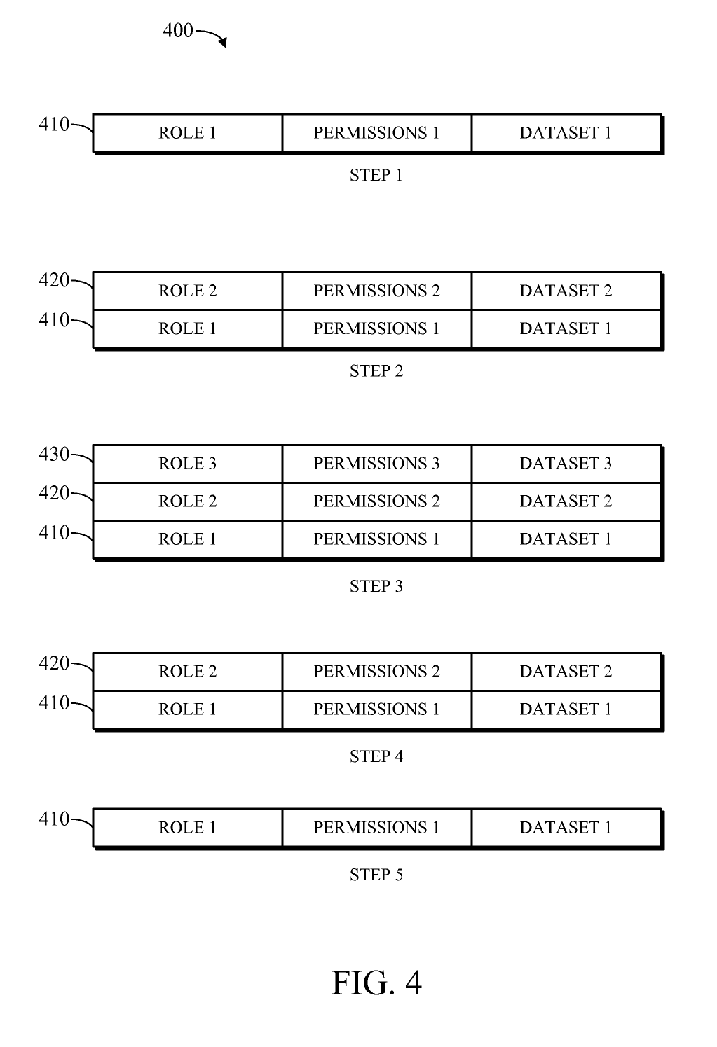

Referring now to FIG. 4, a block diagram 400 of the stack used for “role impersonation” in accordance with a CRM mechanism in accordance with a preferred embodiment of the present invention preferred embodiment of the present invention is shown. As shown in FIG. 4, each of Role 1, Role 2, and Role 3 have a set of permissions and datasets that are configured as part of their respective role. Each of these roles, permissions, and datasets are configured to allow a user to have access to the functions and data associated with their job. By configuring different roles, the security and accessability of the system is significantly enhanced. Additionally, by allowing user to “impersonate” other roles, the flexibility of the system is also enhanced.

In Step 1, a user logs into CRM system 100 of FIG. 1 and Role 410, associated with a user that has only one role, is pushed onto stack 400. Alternatively, should the user have multiple roles, the user may be presented with a drop down box, listing each of the roles that the user has been granted permission to impersonate. Should the user choose to impersonate a second role, Role 420, for example, then Role 420, along with the associated permissions and dataset is “pushed” onto the stack. This is illustrated in Step 2, with both Role 410 and Role 420 being on stack 400. Similarly, by choosing to impersonate Role 430, the permissions and dataset associated with Role 430 are pushed onto stack 400 and the user can access the functions and data prescribed by the system boundaries for Role 430. Then, as shown in Step 4 and Step 5, the user may choose to revert back to the previous roles, and the discarded roles are “popped” off of stack 400. At each step of the way, the user has the rights and authority to access the various functions and data associated with the then-current role. Once there is only a single role left, then the user cannot back out any more and may choose to impersonate another role or simply log off the system.

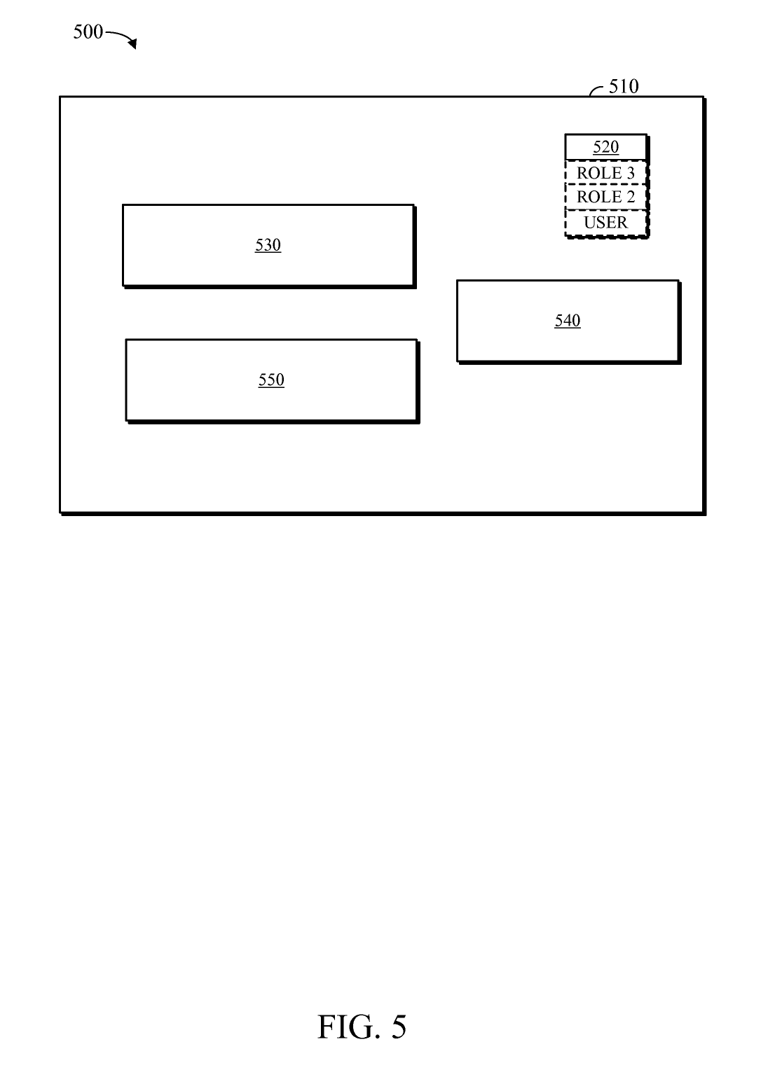

Referring now to FIG. 5, a schematic representation of a user web page for interfacing with a CRM mechanism in accordance with a preferred embodiment of the present invention is shown. As shown in FIG. 5, a program interface 510, rendered by user interface 227 of FIG. 2, will display a series of program elements 530, 540, and 550. Each of these program elements will allow the user to access certain functions of CRM system 100 of FIG. 1 and/or data elements contained in database 223 of FIG. 2.

In addition, in the most preferred embodiments of the present invention, program interface 510 will typically display a status indicator 520. Status indicator 520 will be used to display the current user and offer the current user the ability to log out of CRM system 100 of FIG. 1 or change the impersonation status of the user. For example, if a user log into CRM system 100 of FIG. 1, and that user has only a single role, then the user will be taken directly to program interface 510 and the functions and data associated with that current users role will be available and the user may access those functions and data. However, if the user has been granted permission to impersonate additional roles, then status indicator 520 may be configured as a drop down box, with each of the available roles displayed in the drop down box. In this fashion, the user can rapidly select and navigate between various roles in CRM system 100 of FIG. 1.

Lastly, it should be appreciated that these embodiments are preferred exemplary embodiments only, and are not intended to limit the scope, applicability, or configuration of the invention in any way. Rather, the foregoing detailed description provides those skilled in the art with a convenient road map for implementing one or more preferred exemplary embodiments of the invention, it being understood that various changes may be made in the function and arrangement of elements described in the exemplary preferred embodiment without departing from the spirit and scope of the invention as set forth in the appended claims.

1. An apparatus comprising:
at least one processor;
at least one memory coupled to said at least one processor;
at least one database residing in said at least one memory; and
a CRM mechanism residing in said memory, said CRM mechanism comprising at least one of:
a program control mechanism;
a graphics mechanism;
a communications compliance mechanism;
a cross-selling mechanism;
a mail reply mechanism;
a user and role management mechanism;
a data management mechanism; and
a marketing mechanism.

2. The apparatus of claim 1 further comprising an impersonation mechanism residing in said memory, said impersonation mechanism being configured to allow a user to rapidly switch from a first role to a second role, wherein each of said first role and said second role comprise, respectively, a first set of permissions and a second set of permission and a first dataset and a second dataset.

3. The apparatus of claim 1 wherein said CRM mechanism comprises:
a program control mechanism;
a graphics mechanism;
a communications compliance mechanism;
a cross-selling mechanism;
a mail reply mechanism;
a user and role management mechanism;
a data management mechanism; and
a marketing mechanism.

4. The apparatus of claim 1 further comprising:
an email server residing in said at least one memory;
a fax server residing in said at least one memory; and
a security mechanism residing in said at least one memory.

5. A computer-implemented method, said method comprising the steps of:
creating an activity program via a CRM mechanism, said CRM mechanism residing in a computer memory and being executed by at least one processor, said CRM mechanism comprising at least one of:
a program control mechanism;
a graphics mechanism;
a communications compliance mechanism;
a cross-selling mechanism;
a mail reply mechanism;
a user and role management mechanism;
a data management mechanism; and
a marketing mechanism.

6. The method of claim 6 further comprising the step of further comprising the step of switching from a first role to a second role, wherein each of said first role and said second role comprise, respectively, a first set of permissions and a second set of permission and a first dataset and a second dataset.

7. A computer-readable medium encoded with a computer program for managing communications with at least one contact, said computer program being configured to:
create an activity program via a CRM mechanism, said CRM mechanism comprising at least one of:
a program control mechanism;
a graphics mechanism;
a communications compliance mechanism;
a cross-selling mechanism;
a mail reply mechanism;
a user and role management mechanism;
a data management mechanism; and
a marketing mechanism;
said CRM mechanism being configured to display or transmit said at least one communication to said at least one contact via a printed message, an email, or a gift that is shipped to said at least one contact.

8. The computer-readable medium of claim 18 wherein said computer-readable medium comprises at least one of recordable media and transmission media.
